(19) United States
(12) Patent Application Publication
(10) Pub. No.: US 2009/0289764 A1
(43) Pub. Date: Nov. 26, 2009

(54) INSTANT PROMOTIONAL MEDIA USING AN IDENTIFICATION TAG

(76) Inventor: Fu-Sheng CHIU, Taipei city (TW)

Correspondence Address: SINORICA, LLC, 2275 Research Blvd., Suite 500, ROCKVILLE, MD, 20850, US

(21) Appl. No.: 12/124,309

(22) Filed: May 21, 2008

(51) Int. Cl. H04Q 5/22

(52) U.S. Cl. 340/10.1

(57) ABSTRACT

A method for retrieving promotional media relevant to a product using a portable identification tag reader is disclosed. An identification tag is associated with the product. Relevant promotional media and information about the product are store on a server. The identification tag comprises a link pointing to the address of the server. When a customer uses a mobile electronic device to read the identification tag the link is decoded and the electronic device connects to the server via a network. The relevant promotional media and additional information is downloaded and displayed on the electronic device for the customer to interact with the media and information.

### BACKGROUND OF THE INVENTION

1. Field of the Invention

The present invention relates to acquiring promotional information. More specifically, the present invention discloses a method for instantly acquiring promotional media and information relevant to a product using an identification tag.

2. Description of the Prior Art

A wide variety of products are available to consumers. However, information about each individual product is limited to the amount of data that can be printed on the package or container of the product. This shortage of adequate product information is a disadvantage for consumers and retailers.

Additionally, labels or packages printed in various languages may be unreadable by many consumers leaving the consumer to guess about product contents or product specifications.

Furthermore, if a consumer wants to know more about a product they need to manually locate the information. For example, the consumer may have to visit the retailer and discuss the product with a clerk or visit the manufacturer's web site and navigate the web site to try to find the information. This is not only time consuming but also frustrating for consumers who want the information immediately.

Moreover, documentation about a product is often lost or misplaced. After a period of time if there is a question or problem with the product the user must request an additional copy of the documentation. To do so the consumer must take note of such data as the brand name, model number, etc. and provide it to the manufacturer who must then locate the documentation. This is highly inconvenient and ineffective.

Therefore, there is need for an improved method of instantly acquiring promotional media and information about a product by a potential customer.

### SUMMARY OF THE INVENTION

To achieve these and other advantages and in order to overcome the disadvantages of the conventional method in accordance with the purpose of the invention as embodied and broadly described herein, the present invention provides a method of instantly acquiring relevant promotional media and information about a product by reading data of an identification tag using a mobile electronic device.

An identification tag is attached or printed on an object, for example, a consumer product. The identification tag (ID tag) comprises a link that points to a location on a network where additional promotional media and information relevant to the product are stored. An ID tag reader reads the link and accesses the network. The relevant promotional media and information is then located and downloaded to the ID tag reader and displayed. As a result, a potential customer can easily acquire additional promotional media and information about the product using the mobile electronic ID tag reader.

The mobile electronic ID tag reader comprises, for example, a handheld ID tag reader, a cellular telephone, a personal digital assistant (PDA), or a portable computer. The ID tag comprises, for example, a ubiquitous ID tag, a quick response (QR) code, radio frequency (RF) tag, radio frequency identification (RFID) tag, universal product code (UPC), or other type of coding capable of relaying a link to a mobile electronic device.

An object of the present invention is to provide a method for conveniently retrieving promotional media and information or data related or relevant to a product. A potential customer simply uses the portable device to read data of an ID tag associated with or attached to a product or printed in a print medium. The method automatically retrieves the relevant promotional media and information and displays it for the customer. The customer is not required to manually input any data, however the customer can make certain selections of which type of promotional media and information to retrieve if desired.

The promotional media comprises, for example, video advertisements, electronic coupons, instructional videos, or assembly instructions and videos. The promotional media is displayed on the portable ID tag reader, a kiosk, or a display such as a television. When displayed on a television other customers will also view the promotional media which can influence and promote more sales.

These and other objectives of the present invention will become obvious to those of ordinary skill in the art after reading the following detailed description of the preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1A-1C are drawings illustrating a promotional media and information retrieval system according to an embodiment of the present invention;

FIG. 2A is a drawing illustrating an example of a QR code;

FIG. 2B is a drawing illustrating an example of an RFID tag;

FIG. 2C is a drawing illustrating an example of a UPC code; and

FIGS. 3A-3D are flowcharts illustrating methods of acquiring information relevant to an object according to embodiments of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

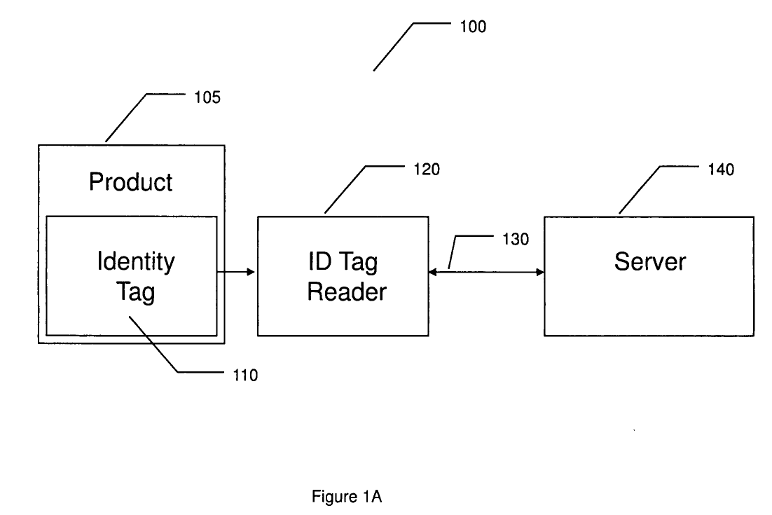

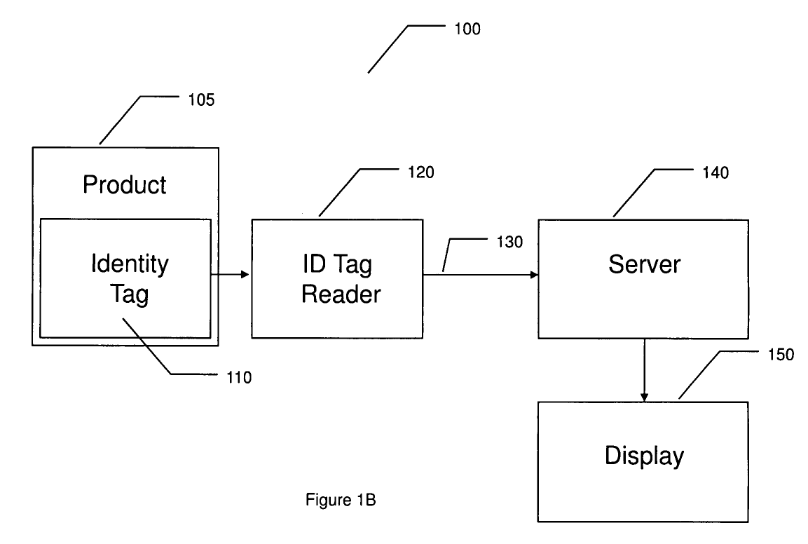

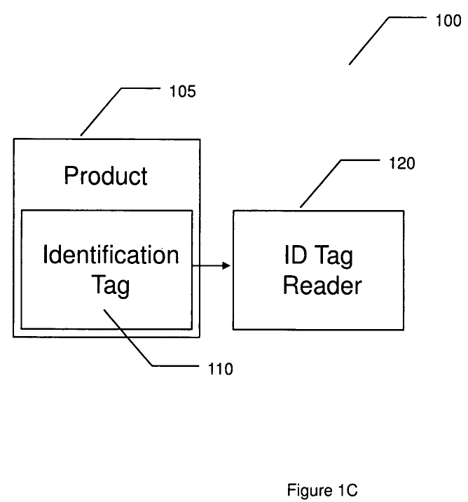

Refer to FIG. 1A, which is a drawing illustrating a promotional media and information retrieval system according to an embodiment of the present invention.

In the embodiment shown in FIG. 1 the promotional media and information retrieval system 100 comprises a product 105, an ID tag 110, an ID tag reader 120, a network 130, and a network server 140. Promotional media and information about the product 105 is stored on the network server 140. The promotional media and information comprises, for example, video advertisements, electronic coupons, instructional videos, assembly instructions and videos, product description, warranty information, competitive pricing, tutorial, product description, or other promotional media and information relevant to the product 105. A link to the information is embedded in, stored in, or printed on the ID tag 110.

The ID tag reader 120 reads the ID tag 110 and acquires the link to the promotional media and information. The ID tag reader 120 then accesses the network server 140 via the network 130 and retrieves the promotional media and information relevant to the product 105. Once the media is downloaded to the ID tag reader 120 the promotional media is displayed. As a result, a customer can easily obtain additional information relevant to a product.

Refer to FIG. 1B, which is a drawing illustrating a promotional media and information retrieval system according to an embodiment of the present invention. The embodiment illustrated in FIG. 1B is similar to the embodiment shown in FIG. 1A. However, in this embodiment the promotional media and information is displayed on a public display 150 such as a television or kiosk display. When displayed on a public display other customers will also view the promotional media which can influence their decision to buy and promotes sales.

Refer to FIG. 1C, which is a drawing illustrating a promotional media and information retrieval system according to an embodiment of the present invention.

In the embodiment illustrated in FIG. 1C the promotional media and information is stored in the ID tag reader 120. Once the ID tag 110 on the product 105 is read the promotional media is instantly displayed on the display of the ID tag reader 120. In this way the overall system is simplified.

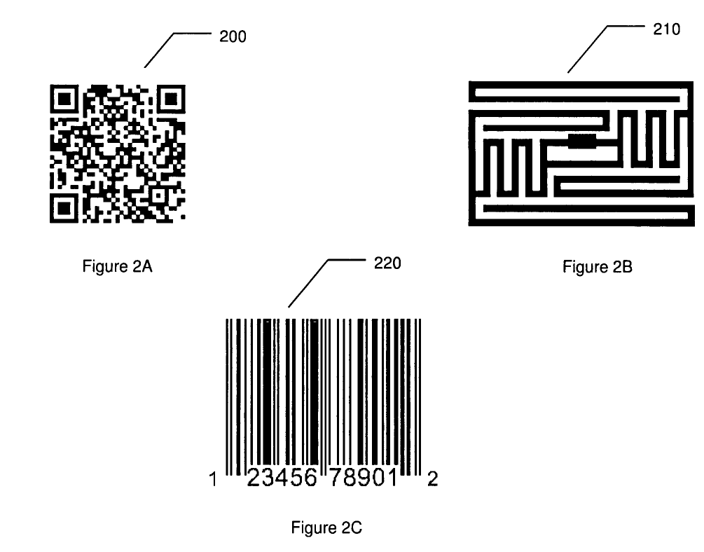

Refer to FIG. 2A, which is a drawing illustrating an example of a QR code, to FIG. 2B, which is a drawing illustrating an example of an RFID tag, and to FIG. 2C, which is a drawing illustrating an example of a UPC code.

In an embodiment of the present invention the ID tag is a QR code 200. The QR code 200 is printed or attached to a product, for example, printed in a magazine or newspaper, printed on a label, or printed on a package. The data encoded into the QR code 200 comprises a link, for example, a universal resource locator (URL) pointing to the network location where the relevant information is stored. For example, a QR code is printed in a magazine advertisement for a product. A customer simply uses the mobile electronic ID tag reader to read the QR code and the electronic device accesses the network server, retrieves promotional media and information about the product, and displays the promotional media and information for the customer. In this example the promotional media and information comprises a video advertisement, product description, discount coupon, or pricing information.

In an embodiment of the present invention the ID tag is an RFID tag 210. The link to promotional media and information is stored in memory of the RFID 210 and the RFID 210 is attached to a product. The ID tag reader reads the link and retrieves promotional media and information about the product for the customer.

In an embodiment of the present invention the ID tag is a UPC. Similar to the QR code embodiment, a link to a product's promotional media and additional information is encoded into the UPC. The ID tag reader reads the link in the UPC and retrieves the promotional media and information.

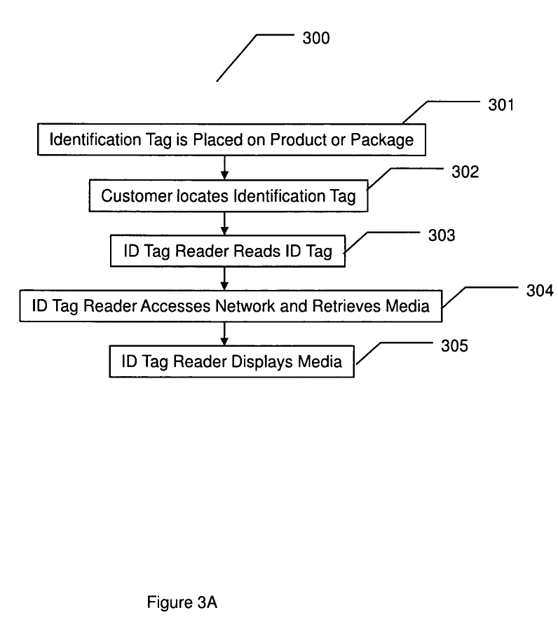

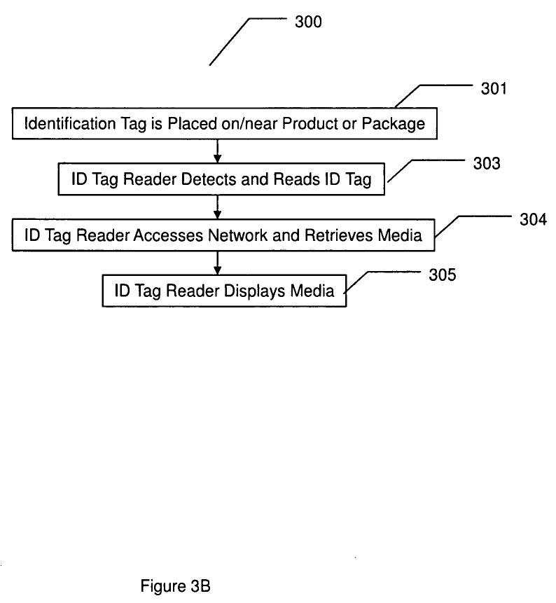

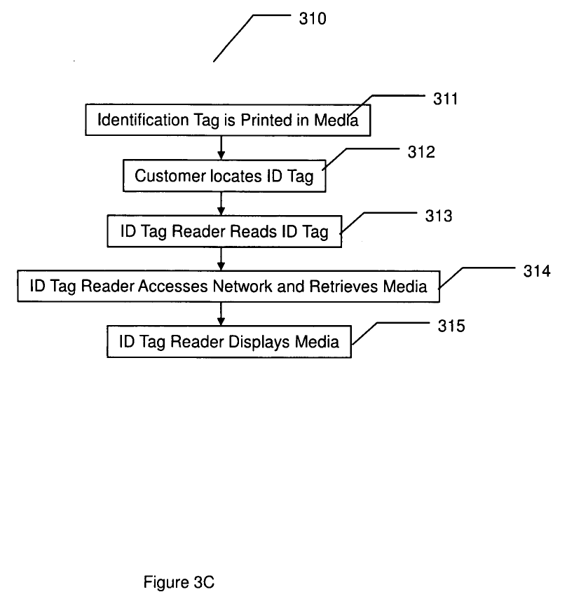

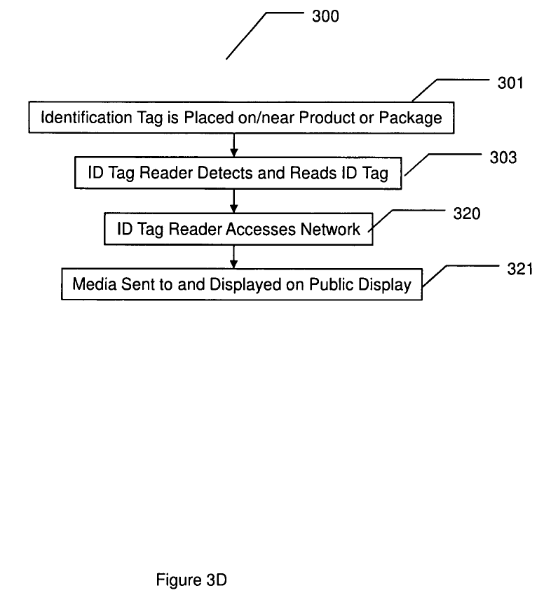

Refer to FIG. 3A, which is a flowchart illustrating a method of acquiring promotional media and information relevant to a product according to an embodiment of the present invention.

As shown in FIG. 3A, the method 300 comprises placing an ID tag on a product or package in Step 301. The ID tag is printed on, attached to, adhered to, embedded in, or part of the product. The ID tag comprises a link to promotional media and information relevant to the product. A customer locates the ID tag in Step 302 and uses an ID tag reader, for example, a mobile electronic device to read the link from the ID tag in Step 303. The ID tag reader accesses a network, for example, the Internet and uses the link to locate a server where promotional media and information about the product is stored and retrieves the promotional media and information in Step 304. The retrieved promotional media and information is then displayed on the ID tag reader in Step 305.

Refer to FIG. 3B, which is a flowchart illustrating a method of acquiring promotional media and information relevant to a product according to an embodiment of the present invention.

The embodiment illustrated in FIG. 3B is similar to the embodiment in FIG. 3A. However, in the embodiment of FIG. 3B the ID tag reader automatically detects the ID tag and reads the link in the ID tag. In this embodiment the customer does not need to locate the ID tag.

As an example of an application using the method of the present invention the following scenario is given. A store attaches a ubiquitous ID tag such as an RFID tag on or next to a product. As a customer approaches the product the ID tag reader detects the RFID tag and accesses the network to retrieve promotional media and information about the product such as a video advertisement, assembly video, instructions, or user manual. In this way, the method provides a virtual clerk for the customer and manpower expense is reduced.

Refer to FIG. 3C, which is a flowchart illustrating a method of acquiring promotional media and information relevant to a product according to an embodiment of the present invention.

The method 310 comprises printing an ID tag in a print medium in Step 311. Encoded in the ID tag is a link to a network server where relevant product promotional media and additional information is stored. A reader of the print medium locates the ID tag in Step 312 and uses a portable ID tag reader to read the link in Step 313. The ID tag reader then accesses a network and using the link locates the network server and retrieves the relevant promotional media and additional information in Step 314. The promotional media and information is then displayed on the ID tag reader in Step 315.

As an example of an application using the method of the present invention the following scenario is given. A beverage company has an advertisement printed in a flyer introducing a new soft drink. A QR code is printed in a part of the advertisement. The QR code contains a URL pointing to the Internet address of a network server. Promotional media and information such as a video advertisement, description of the drink, multimedia advertisements, discount coupons, retail outlet locations, and special offers is stored on the server. A customer seeing the advertisement uses a portable ID tag reader to read the QR code. The ID tag reader accesses the Internet and using the URL in the QR code locates the server and retrieves the various types of promotional media and information. The promotional media and information is then displayed on the ID tag reader and the customer can interact with the promotional media and information.

Refer to FIG. 3D, which is a flowchart illustrating a method of acquiring promotional media and information relevant to a product according to an embodiment of the present invention.

In the embodiment illustrated in FIG. 3D, the ID tag reader detects and reads the ID tag in Step 303. In Step 320 the ID tag reader accesses the server where the promotional media and additional information are stored. The server sends the promotional media and additional information to a public display such as a television in Step 321.

In another embodiment of the present invention the ID tag is displayed on a television or computer monitor. The customer uses a portable device to read the displayed ID tag and the relevant promotional media and information is retrieved. For example, a home shopping channel can display the ID tag such as a QR code while describing a product. In this way the customer can easily retrieve promotional media and additional information about the product or can easily place an order for the product. This embodiment also allows customers to immediately retrieve promotional media and information or place orders when viewing commercials during a broadcast. A small portion of the screen displays the ID tag during the program or commercial and a customer uses a mobile device to read the ID tag.

In another embodiment of the present invention a plurality of ID tags are utilized. For example, one ID tag links to product information and another ID tag links to a product order service.

The method of the present invention is utilized in a wide variety of applications. For example, a product's user manual is stored in electronic format on a central server. When a customer needs more information about using the product the customer simply uses the ID tag on the product or package with a portable device to access the user manual. The customer doesn't have to input model number or other information. As a result, customers can easily obtain additional information about the product.

Another application allows a customer to obtain promotional media such as how-to-assemble instructional videos by reading the ID tag on a product or picture. A user can also get recipes that call for a product by reading the ID tag on the product or package.

Another application allows a customer to obtain translations of relevant information. For example, if a label of a product is written in a language the consumer does not understand, reading the ID tag provides the relevant information in the consumer's language of choice.

Additionally, in embodiments of the present invention the ID tag stays with the product and relevant promotional media and information can be retrieved at any time during the lifetime of the product.

In some embodiments of the present invention the customer selects which type of promotional media and information to retrieve. The customer can select from different categories of media and information depending on the type of information desired. For example, if a customer is looking at a product and wants to know the ingredients they can select nutritional data.

In some embodiments the retrieved relevant promotional media and information is presented in a format where the customer selects from a menu or list of available media and information.

In some embodiments a list or menu of the available relevant promotional media and information is presented to the customer prior to retrieval. The customer selects which information to retrieve.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. A method of acquiring promotional media relevant to a product comprising:
reading an identification tag associated with the product using a portable identification tag reader;
accessing a server where the promotional media is stored;
retrieving the promotional media; and
displaying the promotional media on the portable identification tag reader.

2. The method of acquiring promotional media relevant to a product of claim 1, further comprising attaching the identification tag to the product.

3. The method of acquiring promotional media relevant to a product of claim 1, further comprising printing identification tag in a print medium.

4. The method of acquiring promotional media relevant to a product of claim 1, the identification tag comprising a ubiquitous identification tag, a quick response (QR) code, a radio frequency (RF) tag, a radio frequency identification (RFID) tag, or a universal product code (UPC).

5. The method of acquiring promotional media relevant to a product of claim 1, the identification tag comprising a link to a location of the promotional media.

6. The method of acquiring promotional media relevant to a product of claim 5, the link comprising a universal resource locator (URL).

7. The method of acquiring promotional media relevant to a product of claim 1, the portable identification tag reader comprising a cellular telephone, a personal digital assistant (PDA), or a portable computer.

8. The method of acquiring promotional media relevant to a product of claim 1, the promotional media comprising video advertisements, assembly instructions, product explanation, warranty information, competitive pricing, tutorial, product description, pricing comparison, recipe, discount coupon, user instructions, or a combination of these.

9. A method of acquiring promotional media relevant to a product comprising:
reading an identification tag associated with the product to obtain a link to the promotional media;
accessing a location pointed to by the link;
retrieving the promotional media; and
displaying the promotional media.

10. The method of acquiring promotional media relevant to a product of claim 9, further comprising attaching the identification tag to the product.

11. The method of acquiring promotional media relevant to a product of claim 9, further comprising printing the identification tag in a print medium.

12. The method of acquiring promotional media relevant to a product of claim 9, the identification tag comprising a ubiquitous identification tag, a quick response (QR) code, a radio frequency (RF) tag, a radio frequency identification (RFID) tag, or a universal product code (UPC).

13. The method of acquiring promotional media relevant to a product of claim 9, the link comprising a universal resource locator (URL).

14. A method of acquiring promotional media relevant to a product using a portable identification tag reader comprising:
associating an identification tag with a product, the identification tag comprising a link to the promotional media;
reading the link by the portable identification tag reader;
accessing a network server where the promotional media is stored; and
displaying the promotional media on the portable identification tag reader.

15. The method of acquiring promotional media relevant to a product using a portable identification tag reader of claim 14, further comprising attaching the identification tag to the product.

16. The method of acquiring promotional media relevant to a product using a portable identification tag reader of claim 14, further comprising printing the identification tag in a print medium.

17. The method of acquiring relevant promotional media relevant to a product using a portable identification tag reader of claim 14, the identification tag comprising a ubiquitous identification tag, a quick response (QR) code, a radio frequency (RF) tag, a radio frequency identification (RFID) tag, or a universal product code (UPC).

18. The method of acquiring promotional media relevant to a product using a portable identification tag reader of claim 14, the link comprising a universal resource locator (URL).

19. The method of acquiring promotional media relevant to a product using a portable identification tag reader of claim 14, the portable identification tag reader comprising a cellular phone, a personal digital assistant (PDA), or a portable computer.

20. The method of acquiring promotional media relevant to a product using a portable identification tag reader of claim 14, the promotional media comprising video advertisements, product explanation, assembly instructions, warranty information, competitive pricing, tutorial, product description, pricing comparison, recipe, discount coupon, user instructions, or a combination of these.
